(19) United States
(12) Patent Application Publication
(10) Pub. No.: US 2005/0091781 A1
(43) Pub. Date: May 5, 2005

(54) Device for cleaning reticle box

(75) Inventors: Jae-Hyun Yang, Sungnam-si (KR); Yo-Han Ahn, Yongin-si (KR); Tae-Jin Hwang, Yongin-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 10/980,020

(22) Filed: Nov. 3, 2004

(30) Foreign Application Priority Data
Nov. 3, 2003 (KR) 2003-77394

(51) Int. Cl. B08B 11/00

(52) U.S. Cl. 15/303

(57) ABSTRACT

The present invention relates to a reticule storage device. After the reticule storage device influxes external airs using a motor and a fan, it provides the external airs filtered by a filter to a reticule storage shelf in a chamber. According to the present invention, a nitrogen gas supply pipe is installed on one end of the chamber. In addition, the nitrogen gas supplier is installed to be connected from the nitrogen gas supplier to the reticule storage shelf. Several nitrogen gas supply nozzles are installed on an end portion of the nitrogen gas supply pipe, so that nitrogen gas is supplied to maintain a regular pressure in the chamber when a motor inflowing external airs is stopped. As a result, in case that an apparatus is stopped due to a problem of the apparatus for many hours, or an external voltage is not supplied due to a problem of the external problem, nitrogen gases may be purged in the apparatus. Accordingly, the purity in the apparatus can be maintained, so that it is possible to prevent a reticule kept in the apparatus from a particle contamination.

### CROSS-REFERENCE TO RELATED APPLICATIONS

This U.S. non-provisional patent application claims priority under 35 U.S.C. § 119 of Korean Patent Application 2003-77394 filed on Nov. 3, 2003, the entire contents of which are hereby incorporated by reference

### BACKGROUND OF THE INVENTION

1. Field of the Invention

The present disclosure relates to reticles, and more particularly, an apparatus for cleaning a reticle box.

2. Description of Related Art

Reticles are used for photolithography. Reticles are plates composed of quartz having minute patterns. Care needs to be taken when handling the reticles so as not to damage the patterns. Further, the reticles may be easily contaminated. Thus, when loading the reticle on an exposure apparatus or unloading the reticle from the exposure apparatus, the reticle is placed in a reticle box.

An example of a reticle box is the SMIF (Standard Mechanical Interface) pod manufactured by ASYST TECHNOLOGIES INC., which may be used in conjunction with an exposure apparatus manufactured by ASML. The SMIF is a kind of system for storing the reticles, reducing the likelihood of particle contamination.

FIG. 1 shows a front view of the reticle box. As shown in FIG. 1, the SMIF pod or reticle box 10 includes slots 12 formed in two columns. The slots 12 are suitable for receiving reticles 20. The reticles 20 are inserted in the slots 12 so that the reticles 20 are stored in the reticle box 10. The reticles 20 are loaded in the reticle box 10 or unloaded from the reticle box 10 when needed.

As illustrated in FIGS. 2(A) and 2(B), the particles may be found on the backside of the reticle 20. FIG. 2(A) depicts a particle map showing particles in a dot circle and FIG. 2(B) is an image of particles captured by microscopy.

FIG. 3 is a graph showing an example of particle composition. The compositions include Al, Ni, O, and S. The Si component is due to the reticle. According to FIG. 4, the reticle box is composed of Al, Ni, O, and S. These elements match the compositions of particles shown in FIG. 3.

The particles occurring on the backside of the reticle may be the result of contact with the slots of the reticle box. Therefore, cleaning of the reticle box is needed. One method of removing particles is wet cleaning. In wet cleaning, however, a cleaning solution may react with the S or N of the reticle box, and produce H₂SO₄ or NH₃. H₂SO₄ or NH₃ may cause other pollutants or environmental problems.

Therefore, a need exists for an apparatus for dry cleaning a reticle box.

### SUMMARY OF THE INVENTION

According to an embodiment of the present disclosure, a reticle box cleaner comprises a cleaning room for a reticle box to be contained therein. The reticle comprises a plurality of slots to support reticles. The reticle box cleaner further comprising an injection portion for injecting a purge gas into the cleaning room such that the purge gas passes through the reticle box contained in the cleaning room, and an exhaust portion for exhausting the purge gas that passed through the reticle box contained in the cleaning room.

The cleaning room comprises a door that allows the reticle box to be received and removed. The cleaning room comprises a structure for fixing the reticle box in the cleaning room.

The injection portion comprises a plurality of injection ports arranged in rows on a sidewall of the cleaning room, an injection device for injecting the purge gas, and an injection line for carrying the purge gas from the injection device to the plurality of injection ports, wherein one end of the injection line is connected to the injection device, and wherein the opposite end of the injection line is divided and connected to the plurality of injection ports individually.

The injection portion further comprises a gas source for supplying the injection device with the purge gas. The injection device comprises a mass flow controller or a regulator. Each injection port corresponds to a respective slot of the plurality of slots. A number of the injection ports may be greater than a number of the slots, and a distance between two neighboring injection ports may be less than a distance between two neighboring slots.

The exhaust portion comprises an intake device for aspirating the purge gas passed through the reticle box contained in the cleaning room, and an exhaust duct for exhausting the purge gas aspirated by the intake device.

The intake device comprises a blower. The exhaust portion further comprises a member for filtering the purge gas. The purge gas is not chemically reactive. The purge gas is selected from the group consisting of inert gas, nitrogen gas, and air.

The reticle box cleaner further comprises a plurality of holes between the cleaning room and the exhaust portion.

According to another embodiment of the present disclosure, a reticle box cleaner comprises a cleaning room for the reticle to be contained therein. The reticle comprises a plurality of slots to support reticles. The reticle box cleaner further comprising an injection portion for injecting a purge gas into the reticle box contained in the cleaning room, the injection portion including a plurality of injection ports arranged in a row on a sidewall of the cleaning room, an injection device for injecting the purge gas, and a forked injection line for carrying the purge gas from the injection device to the plurality of injection ports, and an exhaust portion for exhausting the purge gas passed through the reticle box contained in the cleaning room, the exhaust portion including an intake device for drawing the purge gas from the cleaning room and an exhaust duct for the passage of the purge gas.

The cleaning room comprises a door that allows the reticle box to be received and removed. The cleaning room comprises a structure for fixing the reticle box onto a bottom of the cleaning room.

The injection portion further comprises a purge gas source for supplying the purge gas to the injection device. The injection device comprises a mass flow controller or a regulator. Each of the injection ports corresponds to a respective slot of the plurality of slots. The number of injection ports may be higher than the number of slots, and the distance between two neighboring injection ports may be shorter than the distance between two neighboring slots. The injection device comprises a blower.

The exhaust portion further comprises a member for filtering the purge gas. The purge gas is not chemically reactive. The purge gas is selected from the group consisting of inert gas, nitrogen gas, and air.

The reticle box cleaner further comprises a plurality of holes between the cleaning room and the exhaust portion.

According to an embodiment of the present disclosure, a reticle box comprises a cleaning room for the reticle box having a plurality of slots to support reticles, the cleaning room including a door that allows the reticle box to be received and removed, an injection portion for injecting a purge gas into the reticle box contained in the cleaning room, the injection portion including a plurality of injection ports arranged in row on a sidewall of the cleaning room, an injector for injecting the purge gas, and an injection line for carrying the purge gas from the injection device to the plurality of injection ports, wherein one end of the injection line is connected to the injection device, and wherein the opposite end of the injection line is divided and connected to the plurality of injection ports individually, and an exhaust portion for exhausting the purge gas passed through the reticle box contained in the cleaning room, the exhaust portion including an aspirator for aspirating the purge gas, an exhaust duct for the passage of the purge gas, and a filter for purifying the purge gas.

The injector comprises a mass flow controller or a regulator. The aspirator comprises a blower. The purge gas is not chemically reactive. The purge gas comprises at least one of inert gas, nitrogen and air.

The reticle box cleaner further comprises a plurality of holes between the cleaning room and the exhaust portion.

### BRIEF DESCRIPTION OF THE DRAWINGS

The accompanying drawings are included to provide a further understanding of the invention, and are incorporated in and constitute a part of this specification. The drawings illustrate exemplary embodiments of the present invention and, together with the description, serve to explain principles of the present invention. In the drawings:

FIG. 1 shows a front view of a reticle box.

FIG. 2 shows defects caused by the reticle box.

FIG. 3 shows a graph of particle composition within the reticle box.

FIG. 4 shows a graph of the composition of slots of the reticle box.

FIG. 5 shows a perspective view of a reticle box cleaner according to an embodiment of the present disclosure.

FIG. 6 shows a side view of a reticle box cleaner according to an embodiment of the present disclosure.

FIG. 7 shows a graph of the cleaning efficiency of a reticle box cleaner according to an embodiment of the present disclosure.

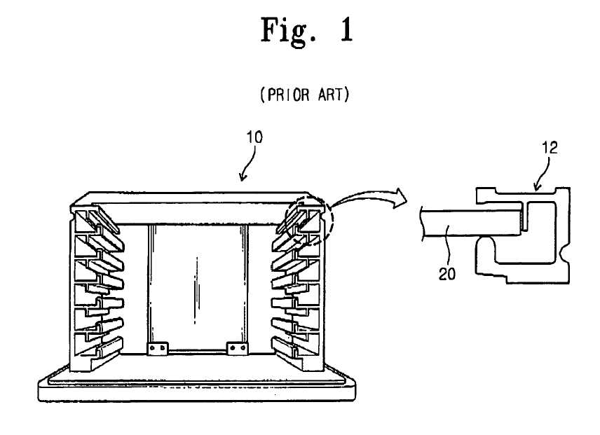

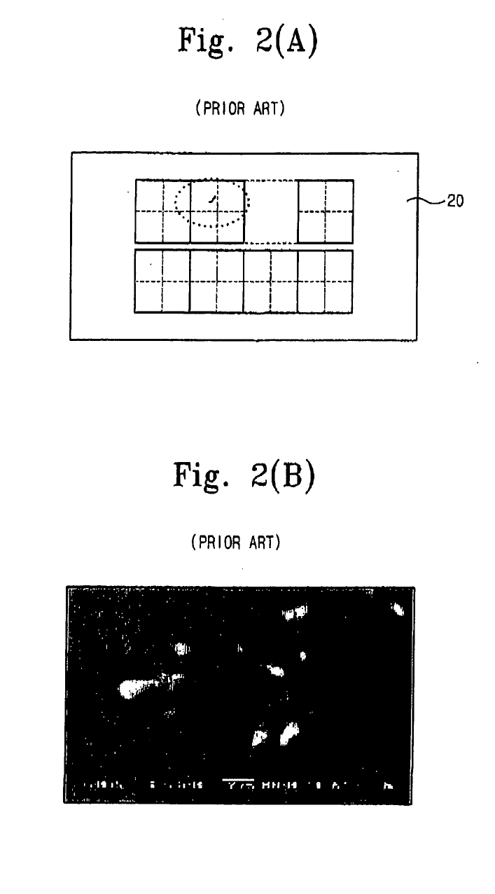

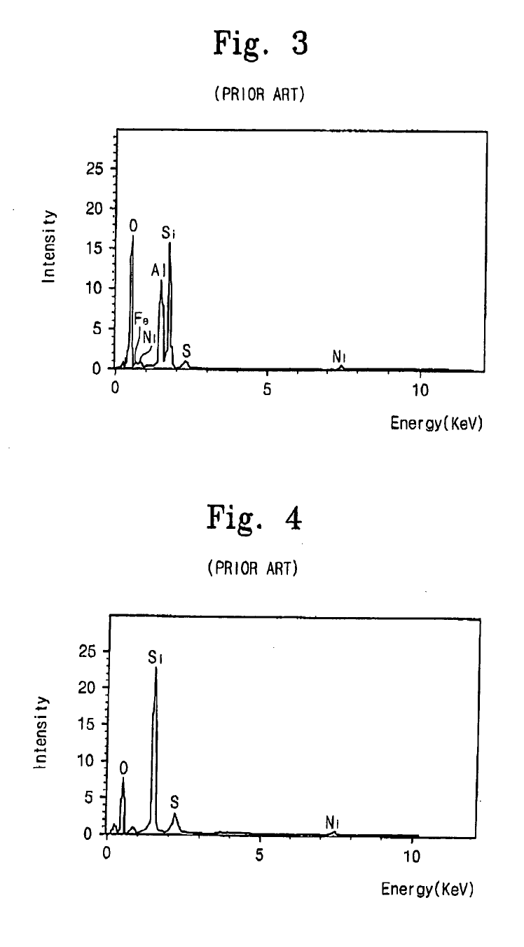

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the invention to those skilled in the art. Like numerals refer to like elements throughout the specification.

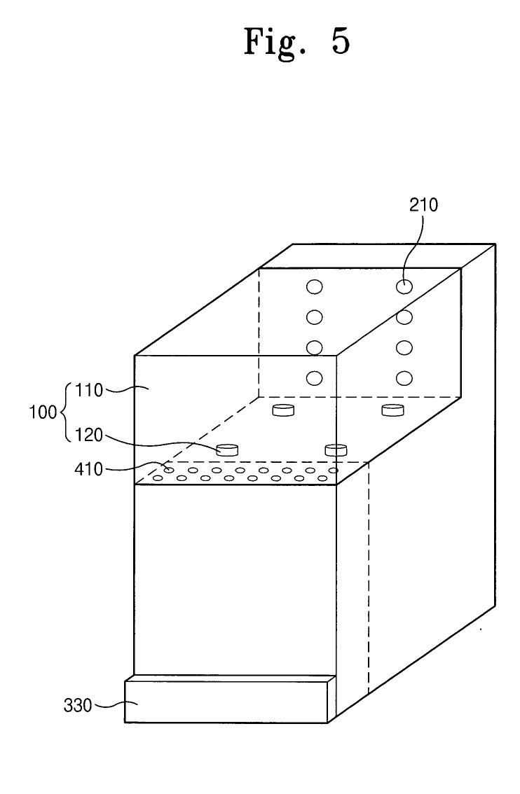

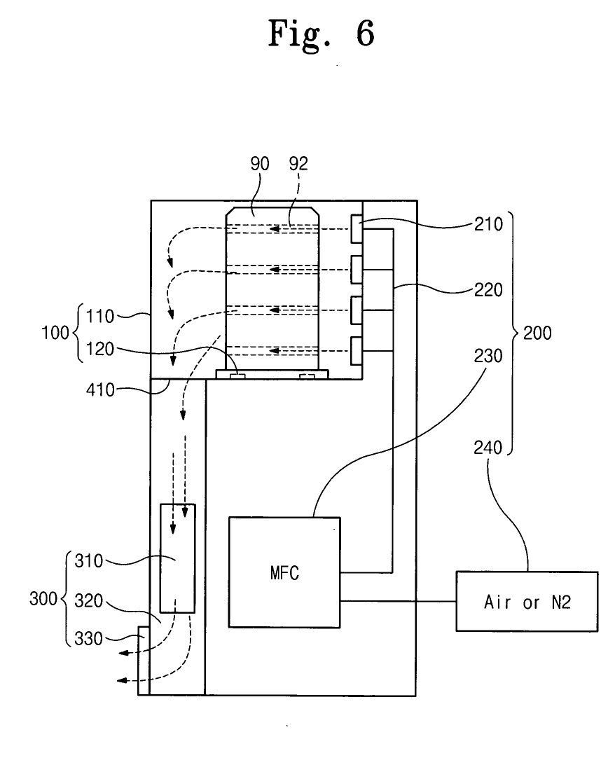

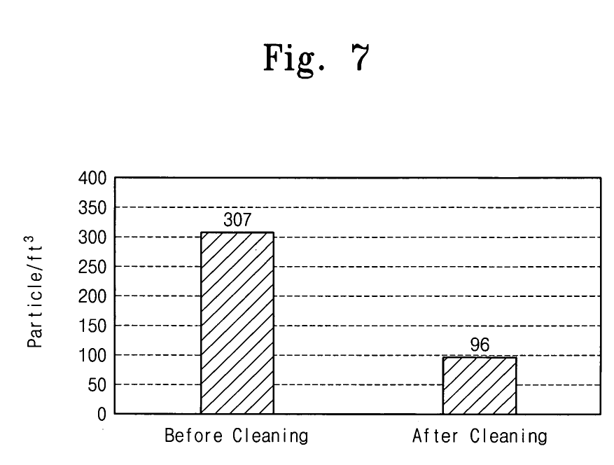

FIG. 5 is a perspective view and FIG. 6 is a side view of a reticle box cleaner according to an embodiment of the present disclosure. FIG. 7 is a graph of the cleaning efficiency of a reticle box cleaner according to an embodiment of the present disclosure.

According to FIGS. 5 and 6, the reticle box cleaner includes a cleaning room 100 to accommodate a reticle box 90 to be cleaned, an injection portion 200 to inject a purge gas into the reticle box 90 contained in the cleaning room 100, and an exhaust portion 300 to aspirate the purge gas passed through the reticle box 90 in the cleaning room 100 and exhaust the purge gas from the cleaning room 100.

The cleaning room 100 has a sufficient capacity for accommodating the reticle box 90 to be cleaned. A sidewall of the cleaning room 100 includes a door 110 that allows the reticle box to be received with the cleaning room 100 and to be removed from the cleaning room 100. According to an embodiment of the present disclosure, the door 110 is installed in front sidewall of the cleaning room 100. However, the position of the door is not limited to the sidewall, and the door 110 could be installed in any wall of the cleaning room 100. The door 110 can be a clamshell type, a sliding type or the like.

A structure 120, for example a kind of pin, may be disposed on the bottom of the cleaning room 100, which can fix the reticle box 90 to the bottom of the cleaning room 100. If the reticle box 90 has grooves that match with the pins 100, the pins 100 may be inserted into the grooves to fix the reticle box 90.

The injection portion 200 injects a predetermined purge gas into the reticle box 90 contained in the cleaning room 100. The injection portion 200 includes an injector 230 to inject the purge gas to the cleaning room 100, a plurality of injection ports 210 that provide passages for the purge gas to the reticle box 90 in the cleaning room 100, and an injection duct 220 to carry the purge gas from the injector 230 to the ports 210.

The injector 230 is a device for injecting the purge gas into the cleaning room 100. The purge gas is clean and chemically non-reactive to the cleaning room 100. The injector 230 is, for example a mass flow controller or regulator for controlling the flow rate of the purge gas. The purge gas may be, for example, nitrogen, air, or an inert gas such as helium.

The plurality of injection ports 210 are disposed on a sidewall of the cleaning room 100. The purge gas, for example, nitrogen or clean air, is directly injected to the reticle box 90 through the injection ports 210. Particles may occur at the slots 92 of the reticle box 90 because the reticle is put in the slot 92. Therefore, each port 220 is preferably disposed to be correspondent to each slot 92, such that the purge gas flows easily in the slots 92 of the reticle box 90. To realize a one-to-one correspondence between the ports 210 and the slots 92, the number and interval of the ports 210 are preferably substantially similar to those of the slots 92. The ports 210 are distributed in at least in two columns vertically on the sidewall of the cleaning room 100. Optionally, the number of the ports 210 may be greater than that of the slots 92. The interval of the ports 210 may be less than that of the slots 92; a distribution of the ports 210 may be denser than a distribution of the slots 92.

The injection line 220 carries the purge gas from the injector 230 to the ports 210. The injection line 220 branches out into several parts. One end of the injection line 220 is connected to the injector 230. An opposite end of the injection line 220 is divided into several parts, each part of the injection line 220 connected to a corresponding injection port of the plurality of injection ports 210.

The injection portion 200 may further comprise a gas reservoir 240 for supplying the injector 230 with the purge gas. The gas reservoir 240 supplies the purge gas stably and steadily.

The exhaust portion 300 removes the purge gas passed through the reticle box 90 from the cleaning room 100 and exhausts the purge gas. The exhaust portion 300 includes an aspirator 310 for removing the purge gas from the cleaning room 100, and an exhaust duct 320. A blower may be suitable for the aspirator 310.

The aspirator 310 is disposed inside the exhaust duct 320 draw the purge gas from the cleaning room 100.

The exhaust duct 320 provides a passage for the purge gas flowing to the outside of the reticle box cleaner. The purge gas containing particles after passing through the slots 92 of the reticle box 90 in the cleaning room 100, is drawn into the aspirator 310 and is expelled from the reticle box cleaner. Doted arrows, as illustrated in FIG. 6, indicate the flow of the purge gas. A plurality of holes 410 may be formed between the exhaust duct 320 and the cleaning room 100. There may not be any element between the exhaust duct 320 and the cleaning room 100.

For applications in which the purge gas exhausted from the exhaust duct 320 flows into a Clean Room, it is preferably that the exhaust portion 320 includes a filter 330 disposed at outlet of the exhaust duct 320.

As shown in FIG. 7, when the reticle box is cleaned by the reticle box cleaner according to an embodiment of the present disclosure, the particles are substantially removed, e.g., from about 300 particles/feet³ to about 100 particles/feet³, which is about a 70% particle removal efficiency.

According to an embodiment of the present disclosure, efficient particle removal by dry cleaning may be achieved.

Although the present invention has been described in connection with embodiments of the present disclosure illustrated in the accompanying drawings, it is not limited thereto. It will be apparent to those skilled in the art that various substitutions, modifications and changes may be thereto without departing from the scope and spirit of the invention.

1. An apparatus suitable for use as a reticle box cleaner, the apparatus comprising:
a cleaning room for containing a reticle box, the reticle box including a plurality of slots to support reticles;
an injection portion for injecting a purge gas into the cleaning room such that the purge gas passes through the reticle box contained in the cleaning room; and
an exhaust portion for exhausting the purge gas that passed through the reticle box contained in the cleaning room.

2. The apparatus of claim 1, wherein the cleaning room comprises a door that allows the reticle box to be received into the cleaning room and removed from the cleaning room.

3. The apparatus of claim 1, wherein the cleaning room comprises a structure for fixing the reticle box in the cleaning room.

4. The apparatus of claim 1, wherein the injection portion comprises:
a plurality of injection ports arranged in rows on a sidewall of the cleaning room;
an injection device for injecting the purge gas; and
an injection line for carrying the purge gas from the injection device to the plurality of injection ports, wherein one end of the injection line is connected to the injection device, and wherein the opposite end of the injection line is divided and connected to the plurality of injection ports individually.

5. The apparatus of claim 4, wherein the injection portion further comprises a gas source for supplying the injection device with the purge gas.

6. The apparatus of claim 4, wherein the injection device comprises one of a mass flow controller and a regulator.

7. The apparatus of claim 4, wherein each injection port corresponds to a respective slot of the plurality of slots.

8. The apparatus of claim 4, wherein a number of the injection ports is greater than a number of the slots, and wherein a distance between two neighboring injection ports is less than the distance between two neighboring slots.

9. The apparatus of claim 1, wherein the exhaust portion comprises:
an intake device for aspirating the purge gas passed through the reticle box contained in the cleaning room; and
an exhaust duct for exhausting the purge gas aspirated by the intake device.

10. The apparatus of claim 9, wherein the intake device comprises a blower.

11. The apparatus of claim 9, wherein the exhaust portion further comprises a member for filtering the purge gas.

12. The apparatus of claim 1, wherein the purge gas is not chemically reactive.

13. The apparatus of claim 12, wherein the purge gas is selected from the group consisting of inert gas, nitrogen gas, and air.

14. The apparatus of claim 1, further comprises a plurality of holes between the cleaning room and the exhaust portion.

15. An apparatus for cleaning a reticle box, the device comprising:
a cleaning room for containing the reticle box, the reticle box including a plurality of slots to support reticles;
an injection portion for injecting a purge gas into the reticle box contained in the cleaning room, the injection portion including a plurality of injection ports arranged in a row on a sidewall of the cleaning room, an injection device for injecting the purge gas, and a forked injection line for carrying the purge gas from the injection device to the plurality of injection ports; and
an exhaust portion for exhausting the purge gas passed through the reticle box contained in the cleaning room, the exhaust portion including an intake device for drawing the purge gas from the cleaning room and an exhaust duct for the passage of the purge gas.

16. The apparatus of claim 15, wherein the cleaning room comprises a door that allows the reticle box to be received by the cleaning room and removed from the cleaning room.

17. The apparatus of claim 15, wherein the cleaning room comprises a structure for fixing the reticle box onto a bottom of the cleaning room.

18. The apparatus of claim 15, wherein the injection portion further comprises a purge gas source for supplying the purge gas to the injection device.

19. The apparatus of claim 15, wherein the injection device comprises one of a mass flow controller and a regulator.

20. The apparatus of claim 15, wherein each injection port corresponds to a respective slot of the plurality of slots.

21. The apparatus of claim 15, wherein a number of the injection ports is greater than a number of the slots, and wherein a distance between two neighboring injection ports is less than a distance between two neighboring slots.

22. The apparatus of claim 15, wherein the injection device comprises a blower.

23. The apparatus of claim 15, wherein the exhaust portion further comprises a member for filtering the purge gas.

24. The apparatus of claim 15, wherein the purge gas is not chemically reactive.

25. The apparatus of claim 24, wherein the purge gas is selected from the group consisting of inert gas, nitrogen gas, and air.

26. The apparatus of claim 15, further comprises a plurality of holes between the cleaning room and the exhaust portion.

27. A reticle box cleaner comprising:
a cleaning room for a reticle box, the reticle box having a plurality of slots to support reticles, the cleaning room including a door that allows the reticle box to be received by the cleaning room and removed from the cleaning room;
an injection portion for injecting a purge gas into the reticle box contained in the cleaning room, the injection portion including a plurality of injection ports arranged in a row on a sidewall of the cleaning room, an injector for injecting the purge gas, and an injection line for carrying the purge gas from the injection device to the plurality of injection ports, wherein one end of the injection line is connected to the injection device, and wherein the opposite end of the injection line is divided and connected to the plurality of injection ports individually; and
an exhaust portion for exhausting the purge gas passed through the reticle box contained in the cleaning room, the exhaust portion including an aspirator for aspirating the purge gas from the cleaning room, an exhaust duct for the passage of the purge gas, and a filter for purifying the purge gas.

28. The reticle box cleaner of claim 27, wherein the injector comprises one of a mass flow controller and a regulator.

29. The reticle box cleaner of claim 29, wherein the aspirator comprises a blower.

30. The reticle box cleaner of claim 27, wherein the purge gas is not chemically reactive.

31. The reticle box cleaner of claim 30, wherein the purge gas comprising at least one of inert gas, nitrogen and air.

32. The reticle box cleaner of claim 27, further comprising a plurality of holes between the cleaning room and the exhaust portion.
